(19) United States
(12) Patent Application Publication
(10) Pub. No.: US 2006/0288142 A1
(43) Pub. Date: Dec. 21, 2006

(54) Data bus system

(76) Inventors: Stefan Beyer, Amberg (DE); Peter Hauselt, Poppenricht (DE); Matthias Meier, Poppenricht (DE)

Correspondence Address: HARNESS, DICKEY & PIERCE, P.L.C., P.O.BOX 8910, RESTON, VA, 20195, US

(21) Appl. No.: 11/452,390

(22) Filed: Jun. 14, 2006

(30) Foreign Application Priority Data
Jun. 15, 2005 (DE) 10 2005 027 666.0

(51) Int. Cl. G06F 13/00

(52) U.S. Cl. 710/110

(57) ABSTRACT

A data bus system is disclosed, including a master unit, a first slave unit and at least one further slave unit. For the purposes of slave selection, the master unit includes a code output for outputting a unique code, particularly a Gray code. The first slave unit includes a slave selection input connected to the code output of the master unit. The first slave unit includes a slave selection output, connected to the at least one further slave unit. The first slave unit includes an inverter which inverts a bit of the unique code applied to the slave selection input and outputs it to the slave selection output of the first slave unit.

The present application hereby claims priority under 35 U.S.C. §119 on German patent application number DE 10 2005 027 666.0 filed Jun. 15, 2005, the entire contents of which is hereby incorporated herein by reference.

### FIELD

The invention generally relates to a data bus system which can be used in an automation system, for example in a PLC controller.

### SUMMARY

At least one embodiment of the invention includes an object of further developing a data bus system, particularly for use in an automation system.

Accordingly, in at least one embodiment, a data bus system having a master unit, a first slave unit and at least one further slave unit is provided. A network of this kind has a linear structure. Since channel access for slave units wishing to transmit takes place in an ordered, foreseeable form, it is possible to refer to a deterministic channel access method. In this case of centralized control, bus use rights are allocated by the master unit.

For slave selection, the master unit has a code output for outputting a unique code. A unique code may be, for example, a Gray code. Alternatively, it is also possible to count up or down in bits as the unique code. A unique code of this kind may have two or more bits. In this context, the Gray code (for example) has a reduced susceptibility to interference over other bit value sequences. The text below therefore describes the example Gray code.

For a two-bit signal, for example, a Gray code is the value sequence:
00 10 11 01.

The first slave unit has a slave selection input which is connected to the code input of the master unit. The slave selection input is used to select this first slave unit on the basis of the unique code. For example, a number of connections on the slave selection input of the first slave unit may match a number of connections on the code output of the master unit.

In addition, in at least one embodiment, the first slave unit has a slave selection output which is connected to the at least one further slave unit. To this end, the further slave unit may likewise have a slave selection input which is connected both to the first slave unit and to the master unit.

The first slave unit has an inverter which inverts a bit of the unique code applied to the slave selection input and outputs it to the slave selection output of the first slave unit. In variant refinements of embodiments of the invention, an inverter of this kind may either be in the form of hardware, for example, in the form of a CMOS inverter, or may be provided by software on a processor, particularly on a microcontroller.

In development of at least one embodiment of the invention, each slave unit has an inverter which is connected to the respective slave selection input and to the respective slave selection output.

For example, in one development of at least one embodiment of the invention, a value of the unique code, particularly of the Gray code, is associated with a selection for a slave unit for sending/or receiving data. This value is fixed (for example), wherein a slave unit which is to be added does not need to be configured to a differing value. In one advantageous refinement of at least one embodiment of the invention, the slave units have identical software and/or identical hardware for data communication. This allows what is known as “plug and play” so that a slave unit can be added by plugging it in without the need for manual address allocation. In this case, it is sufficient for the identity of the hardware and software to relate to the data bus system part.

In one example refinement of at least one embodiment of the invention, for data transmission the master unit is networked to each slave unit in parallel via a serial interface, the serial interface preferably containing three wires. This allows simultaneous data transmission in both directions, that is to say from the master unit to the selected slave unit and from the selected slave unit to the master unit.

To simplify synchronization of the data transmission and to use clock generators which are as simple as possible and are therefore not accurate, one advantageous refinement of at least one embodiment of the invention has provision for each slave unit to be designed to generate a clock signal. In this case, the master unit includes a device/method for locking on to the clock signal of the selected slave unit. For example, each slave unit in this case can be designed to generate the clock signal on the basis of a signal applied to the slave selection input.

Advantageously, each slave unit may be designed to turn off the outputs of the serial interface in the event of an error. This allows collisions to be avoided on the serial interface for data transmission between an operational, selected slave unit and an incorrectly operating slave unit which may significantly disturb or totally prevent data communication to the master unit.

In one advantageous refinement of at least one embodiment of the invention, the master unit has a gateway for sending and/or receiving data from another bus. This allows remote control of the functions of the slave units via a central computer connected to the master unit. The central computer controlling an entire production installation, for example. Alternatively, or in combination with interfaces or bus connections to other units, one advantageous refinement of at least one embodiment of the invention has provision for the master unit to have an input unit for manually selecting a slave unit. By way of example, this may be a keypad in connection with a display unit in the form of a display.

A further aspect of at least one embodiment of the invention is the use of a data bus system as described above for driving sensor actuator control units in an automation system, for example in a PLC controller.

### BRIEF DESCRIPTION OF THE DRAWINGS

Example embodiments of the invention are explained in more detail below with reference to drawings, in which:

FIG. 1 shows a schematic block diagram of a data bus system,

FIG. 2 shows a schematic illustration of a time period in a bus activity, and

FIG. 3 shows a selection of slave units using a Gray code within a time period.

Functional elements which correspond to one another have been provided with the same reference symbols in all figures.

### DETAILED DESCRIPTION OF THE EXAMPLE EMBODIMENTS

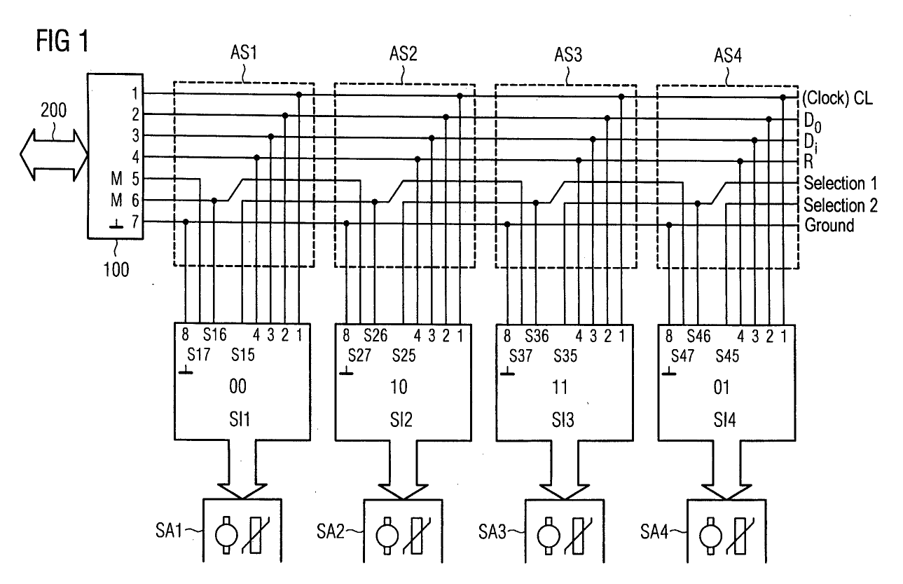

FIG. 1 shows a schematic block diagram of a data bus system based on at least one embodiment of the invention. The master 100 used is a data supply module. In the example embodiment in FIG. 1, the master 100 acts as a “gateway” which allows communication both within the data bus system and with further functional groups, such as a central computer, via another bus system 200, such as a CAN, IQ-Sence or PROFIbus. In addition, or alternatively, the master 100 may also be provided for manual input of data which is transmitted via the data bus system.

For the purpose of transmitting data, the master 100 is connected to four slave units S11, S12, S13 and S14. These slave units S11, S12, S13 and S14 are preferably modules in a compact branching system, with a module containing, in addition to the bus functionality, a component SA1, SA2, SA3 or SA4 with hardware and software for controlling actuators, for measuring sensors, and safety functions. To this end, the component SA1 to SA4 may contain power electronics, for example, such as power semiconductors. It is a control and protection device for, preferably, for motors and affords protection against overload or overtemperature. In this context, the slave unit S11, S12, S13, S14 identifies the connected actuators or sensors independently, assigns them an identification and configures the control software.

The master 100 has provided the slave units S11, S12, S13 and S14 with a clear association with their position in the bus. The components SA1, SA2, SA3 or SA4 may additionally perform different functions, such as engine starter “direct”, “reverse”, “gentle”, etc. The association of the slave units S11, S12, S13 and S14 requires no manual address allocation in this case but rather is managed by a protocol for the bus. By way of example, the master 100 sends control data for an electric motor connected to a component SA1, SA2, SA3 or SA4.

The data bus system is designed for no more than four slave units S11 to S14. The networking within the data bus system is effected in parallel, with the exception of the two lines on the outputs M5 and M6 of the master 100. The line on the output M5 is routed to the input S17 of the first slave unit S11. The slave unit S11 inverts the signal applied to the input S17 and outputs an inverted signal at the output S15. This inverted signal is sent to an input S26 of the second slave unit S12 and to an input S37 of the third slave unit S13. In this case, the inputs S17, S27, S37 and S47 invert the signal applied and output the inverted signal to the outputs S15, S25, S35 and S45.

If both outputs M5 and M6 of the master 100 are at “low potential”, the slave units S11 to S14 respectively receive a value for a Gray code at their inputs as a result of this wiring. On the basis of the case illustrated, the slave unit S11 receives the value “00”, the slave unit S12 receives the value “10”, the slave unit S13 receives the value “11” and the slave unit S14 receives the value “01”. In FIG. 1, the value “00” has an associated selection for communication with the master 100, so that in the case illustrated the slave unit S11 can send and receive via the inputs “1” to “4”. The other slave units S12 to S13 turn off the inputs and outputs “1” to “4”.

To select the slave unit S12, the master 100 applies a HIGH potential to the output M5 and applies a LOW potential to the output M6. As a result of the inversion in the slave unit S11, the inputs S26, S27 of the second slave unit S12 respectively have a LOW potential applied to them, corresponding to the Gray code value “00”. At this time, the second slave unit S12 has been selected for sending and receiving. The result of this process is that the Gray code allows the modules S11, S12, S13 and S14 to be clearly addressed sequentially. The likelihood of a data collision between different slave units S11, S12, S13 or S14 can be significantly reduced through the use of the Gray code.

The application of the successive values of the Gray code allows the master 100 to select the individual slave units S11 to S14 successively for communication in this way. In this context, the Gray code has the particular property that adjacent binary combinations differ only in one digit. Such codes are called single-step or else cyclic. They are used in order to ascertain incorrect intermediate combinations easily. In addition, the use of the Gray code requires no explicit address allocation via the data bus.

For the purpose of communication, the selected slave unit S11, S12, S13 or S14 emits a clock signal C1 to which the master 100 synchronizes itself. Using a data line D_{O}, the master 100 sends data to the selected slave unit S11, S12, S13 or S14 and, using another data line D_{I}, the selected slave unit S11, S12, S13 or S14 sends data to the master 100. The data interchange takes place exclusively between the master 100, which can also be called a router, and the connected slave units S11, S12, S13 or S14. To this end, serial data transfer via the three wires C1, D_{O} and D_{I} is used. A reset line R can be used to reset the selected slave unit S11, S12, S13 or S14.

To allow simple connection of the slave units S11, S12, S13 or S14 to the data bus system, a mechanical standard plug connection AS1, AS2, AS3 and AS4 is provided which allows simple installation of the slave units S11, S12, S13 or S14. The slave units S11, S12, S13 and S14 have identical hardware and an identical configuration. Thus, they can be plugged using any plug connector AS1, AS2, AS3 or AS4. These plug connectors may be part of a populated backplane bus board which allows the entire data bus system to be arranged in a housing. If a slave unit S11, S12, S13 or S14 is faulty or is not present in the slot AS1, AS2, AS3 or AS4, the master 100 recognizes this and can change the Gray code value in order to select another slave unit S11, S12, S13 or S14.

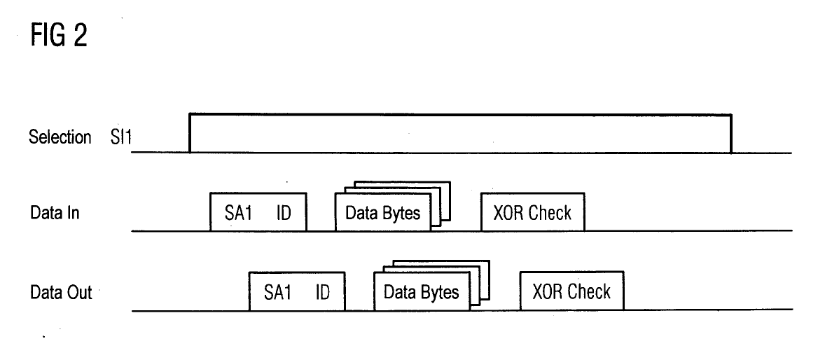

FIG. 2 shows schematically a time period in a bus activity. To keep the technical complexity in the slave units S11, S12, S13, S14 as low as possible the slave units S11, S12, S13, S14, having been selected by the master 100, generate a clock signal and emit a defined message. In the same move, the selected slave unit S11, S12, S13 or S14 receives a message from the master 100, the message being clocked to the clock signal.

FIG. 2 schematically shows a message for the selected slave unit S1. The message comprises three parts. The first byte is used to transmit an identification SA1ID for a component SA1 providing the master 100 with clear information about the functions of a connected device. This may be information about connected sensors or actuators, for example, which can be measured or driven. The second part (data bytes) is reserved for data transmission between the master 100 and the selected slave unit S11. In this context, the size of the second part is dependent on the identification SA1ID of the component SA1, since different functions require different amounts of data. Normally, one byte is sufficient in order to control a standard function, such as that of an engine starter. The third part is used for the data security XOR check. An exclusive-or-checksum is formed over the first two parts.

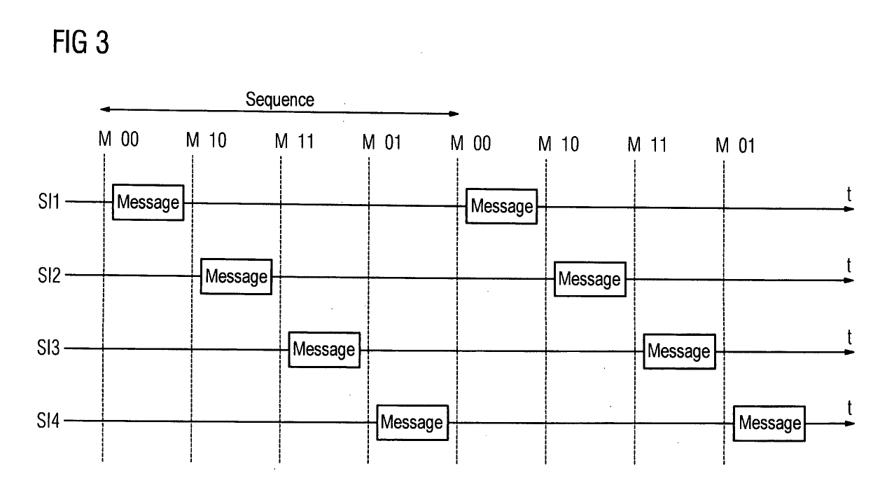

FIG. 3 is used to provide a schematic illustration of connection setup between the master 100 and the slave units S11, S12, S13, S14. The upper area plots the Gray code values M00, M10 etc., which are output at the outputs M5 and M6 of the master 100. After a full sequence, these values are repeated. The respective slave unit S11, S12, S13 or S14 is initialized by the signal M00, M10, etc. The respective selected slave unit S11 to S14 starts the transmission upon the clock signal and communicates a message following initialization by the master 100. Following successful message transmission, the master 100 rotates the Gray code signal in order to poll all the slave units S11 to S14 sequentially in succession. If communication fails, this error is identified and reported by the slave units S11, S12, S13, S14. The outputs on the faulty slave unit S11, S12, S13 or S14 are safely turned off.

Implementing this data bus system in FIGS. 1 to 3 requires only three lines for the data transfer and two lines for the selection of the communicating slave unit S11, S12, S13, S14. The tasks are processed by a microcontroller (not shown), which makes developing complex hardware solutions and ASICs superfluous. Since the software requires only very few resources (MIPS), the tasks can also optionally be undertaken by an already-present processor as well.

The implementation described allows startup identification. This means that upon a restart the master 100 identifies which types of components SA1 to SA4 are connected. In this case, the address corresponds to the position in the setup, that is to say one of the slots AS1 to AS4. The inexpensive solution shown in FIGS. 1 to 3 therefore affords the opportunity to perform control both centrally and “in situ”, with installation and startup being kept simple.

Any of the aforementioned methods may be embodied in the form of a system or device, including, but not limited to, any of the structure for performing the methodology illustrated in the drawings.

Further, any of the aforementioned methods may be embodied in the form of a program. The program may be stored on a computer readable media and is adapted to perform any one of the aforementioned methods when run on a computer device (a device including a processor). Thus, the storage medium or computer readable medium, is adapted to store information and is adapted to interact with a data processing facility or computer device to perform the method of any of the above mentioned embodiments.

The storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, such as floppy disks (trademark), cassette tapes, and removable hard disks; media with a built-in rewriteable non-volatile memory, such as memory cards; and media with a built-in ROM, such as ROM cassettes.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A data bus system, comprising:
a master unit;
a first slave unit; and
at least one further slave unit, wherein, for the purposes of slave selection, the master unit includes a code output to output a unique code, wherein the first slave unit includes a slave selection input connected to the code output of the master unit, wherein the first slave unit includes a slave selection output connected to the at least one further slave unit, and wherein the first slave unit includes an inverter to invert a bit of the unique code applied to the slave selection input and to output the inverted bit to the slave selection output of the first slave unit.

2. The data bus system as claimed in claim 1, wherein the unique code is a Gray code.

3. The data bus system as claimed in claim 1, wherein a value of the unique code is associated with a selection for a slave unit for at least one of sending and receiving data.

4. The data bus system as claimed in claim 1, wherein the slave units include at least one of identical software and identical hardware for data communication.

5. The data bus system as claimed in claim 1, wherein, for data transmission, the master unit is networked to each slave unit in parallel via a serial interface.

6. The data bus system as claimed in claim 1, wherein each slave unit is designed to generate a clock signal.

7. The data bus system as claimed in claim 6, wherein each slave unit is designed to generate the clock signal on the basis of a signal applied to the slave selection input.

8. The data bus system as claimed in claim 1, wherein the slave unit is designed to turn off the outputs of the serial interface in the event of an error.

9. The data bus system as claimed in claim 1, wherein the master unit includes a gateway for at least one of sending and receiving data from another bus.

10. The data bus system as claimed in claim 1, wherein the master unit includes an input unit for manually selecting a slave unit.

11. A method, comprising:
using the data bus system as claimed in claim 1 for driving sensor actuator control units in an automation system.

12. The data bus system as claimed in claim 2, wherein a value of the Gray code is associated with a selection for a slave unit for at least one of sending and receiving data.

13. The data bus system as claimed in claim 1, wherein, for data transmission, the master unit is networked to each slave unit in parallel via a serial interface, the serial interface containing three wires.

14. A method, comprising:
using the data bus system as claimed in claim 1 for driving sensor actuator control units in a PLC controller.

15. The data bus system as claimed in claim 2, wherein the slave units include at least one of identical software and identical hardware for data communication.

16. The data bus system as claimed in claim 2, wherein, for data transmission, the master unit is networked to each slave unit in parallel via a serial interface.

17. A data bus system, comprising:
master means for outputting a unique code;
first slave means for receiving the unique code, for inverting a bit of the unique code received, and for outputting the unique code including the inverted bit; and
at least one further slave means for receiving the unique code including the inverted bit.

18. The data bus system as claimed in claim 17, wherein the unique code is a Gray code.
